(19) United States
(12) Patent Application Publication
(10) Pub. No.: US 2008/0172749 A1
(43) Pub. Date: Jul. 17, 2008

(54) Systems and Methods for Protecting Security Domains From Unauthorized memory Accesses

(75) Inventors: Je-Myoung Ko, Yongin-si (KR); Young-Sik Park, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd

(21) Appl. No.: 11/765,839

(22) Filed: Jun. 20, 2007

(30) Foreign Application Priority Data
Jan. 17, 2007 (KR) 10-2007-0005080

(51) Int. Cl. H04L 9/32

(52) U.S. Cl. 726/27

(57) ABSTRACT

A system can include a plurality of bus masters coupled to a system bus and a plurality of security monitors each configured to monitor at least one of the plurality of bus masters to determine whether an address issued by the at least one bus master matches any address included in a predetermined security domain of the system.

### CROSS-REFERENCE TO RELATED PATENT APPLICATIONS

This application claims priority under 35 U.S.C. §119 from Korean Patent Application No. 10-2007-0005080, filed on Jan. 17, 2007, the disclosure of which is hereby incorporated by reference herein as if set forth in its entirety.

### FIELD OF THE INVENTION

The present invention relates to the field of electronics, and more particularly, to methods and systems for protecting data.

### BACKGROUND

As the use of portable devices such as mobile phones, PDAs (personal digital assistants), or PMPs (portable multimedia players) have increased, broadcast technologies that enable receiving various multimedia content while moving, such as DMB (digital multimedia broadcasting), DVB-H (digital video broadcasting-handheld), or media flow, have been introduced.

However, to prohibit unauthorized and unlawful access while allowing access by a legal user, a device for protecting the whole system including hardware or software may be useful. For this purpose, DRM (digital rights management) is assigned and is supported by most portable devices capable of receiving mobile broadcasts. To observe the core requirements of the DRM, the security domain (i.e., region) of a system should be protected from unauthorized access.

One approach to protecting a security domain includes using an ARM1176 core that supports “TrustZone.” However, considering the time and cost needed for development of hardware, a system satisfying the DRM using an MCU (micro controller unit) that does not support the TrustZone is needed. In particular, there is a need to protect the security domain from an unauthorized access in a system using a dual core of the MCU and a DSP (digital signal processor).

In such a dual core system, the MCU can access an internal memory through a shared address for data communication with the DSP. Since the MCU can access the same address that the DSP accesses, when the MCU is attacked by a hacker, the information of the DSP can be leaked outside or altered by the hacker's attack.

### SUMMARY

Embodiments according to the invention can provide systems and methods for protecting security domains from unauthorized memory accesses. Pursuant to these embodiments a system can include a plurality of bus masters coupled to a system bus and a plurality of security monitors each configured to monitor at least one of the plurality of bus masters to determine whether an address issued by the at least one bus master matches any address included in a predetermined security domain of the system.

In some embodiments according to the invention, a system can include a first processor that is configured to execute a user program. A security domain setting register unit is configured to store information indicating access rights associated with addresses included in a predetermined security domain. A security monitor is coupled to the security domain setting register unit and to the first processor and is configured to monitor whether an address issued by the first processor on a system bus matches any address included in the predetermined security domain of the system.

In some embodiments according to the invention, a method of protecting a security domain of a system can include outputting a first address to access a first address area, comparing the first address to addresses associated with secure areas of a shared memory, the shared memory being accessible to secure and non-secure processes, and allowing or blocking access to the first address based on whether the first address matches any address within the secure areas of the shared memory.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram of a system for protecting a security domain from an unauthorized memory access in some embodiments according to the invention;

FIG. 2 is a block diagram illustrating security domain setting registers in some embodiments according to the invention;

FIG. 3 a schematic representation of a memory mapped that illustrates security domains set based on information programmed in the security domain setting register unit of FIG. 2 in some embodiments according to the invention; and

FIG. 4 is a flowchart illustrating methods of protecting security domains of a system in some embodiments according to the invention.

### DESCRIPTION OF EMBODIMENTS ACCORDING TO THE INVENTION

The invention now will be described more fully hereinafter with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will further be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The invention is also described using flowchart illustrations and block diagrams. It will be understood that each block (of the flowcharts and block diagrams), and combinations of blocks, can be implemented by computer program instructions. These program instructions may be provided to a processor circuit, such as a microprocessor, microcontroller or other processor, such that the instructions which execute on the processor(s) create means for implementing the functions specified in the block or blocks. The computer program instructions may be executed by the processor(s) to cause a series of operational steps to be performed by the processor(s) to produce a computer implemented process such that the instructions which execute on the processor(s) provide steps for implementing the functions specified in the block or blocks.

Accordingly, the blocks support combinations of means for performing the specified functions, combinations of steps for performing the specified functions and program instruction means for performing the specified functions. It will also be understood that each block, and combinations of blocks, can be implemented by special purpose hardware-based systems which perform the specified functions or steps, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

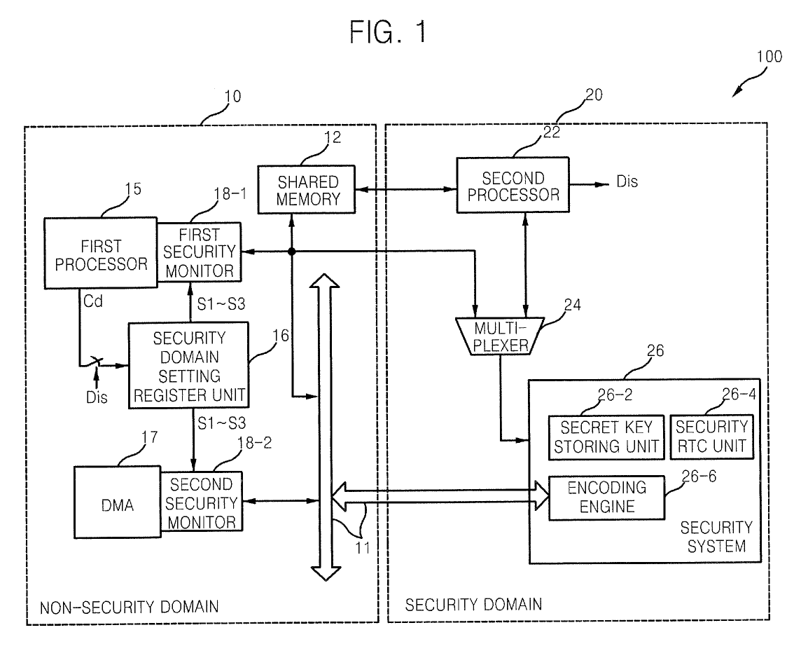

FIG. 1 is a block diagram of a system 100 for protecting a security domain from an unauthorized memory access in some embodiments according to the invention. Referring to FIG. 1, the system 100 can be classified into a non-security domain 10 and a security domain 20. The security domain (or, zone) 20 is an area to limit an unauthorized memory access by an external user, for example, hacker, in the system 100.

The non-security domain 10 is an area excluding the security domain 20 in the system 100 which may be accessible by a hacker via memory. The system 100 includes a system bus 11, a shared memory 12, a plurality of bus masters 15, 17, and 22, a security domain setting register unit16, a plurality of security monitors 18-1 and 18-2, a multiplexer 24, and a security sub-system 26.

The bus masters 15, 17, and 22 have rights to access the system bus 11. A first processor 15, a DMA (direct memory access) device 17, and a second processor 22 represent at least parts of the bus masters having a right to access the system bus 11. In some embodiments according to the invention, the first processor 15 is an application processor that can execute a user program, such as an MCU (micro controller unit). The DMA device 17 can be a typical bus master that is capable of directly accessing a memory and transmitting data.

In some embodiments according to the invention, the second processor 22 performs at least one role of a data processor and a secure processor. The second processor 22 can be a DSP that can access the security domain. The shared memory 12 includes a domain (or, region) which can be shared by the first processor 15, (e.g., the MCU) and the second processor 22 (e.g., the DSP).

Since the address used by the DSP 22 to access the shared memory 12 can be used by the MCU 15, when the MCU 15 is attacked by a hacker, the information stored in the DSP 22 can be leaked to the outside or altered by the hacker's attack. Thus as appreciated by the present inventors, the second processor 22 should be protected from the hacker's attack.

In some embodiments according to the invention, the security sub-system 26 is hardware configured to protect the rights associated with information utilized by an application program of the system 100 or the rights of the application program itself. For example, the security sub-system 26 may be hardware embodied to support the DRM incorporated in some mobile broadcast portable devices.

The security sub-system 26 includes a secret key storing unit 26-2, an RTC (real time clock) unit 26-4, and an encoding engine 26-6. The secret key storing unit 26-2 stores security keys. The security RTC unit 26-4 is a module for providing a safe clock that is protected from being changed by an external user (i.e., a hacker) which can be embodied by software and/or hardware. Thus, the RTC unit 26-4 belongs to the security domain 20.

The encoding engine 26-6 interprets encoded data, such as broadcast content received from the outside, using the secret keys stored in the secret key storing unit 26-2. For example, the broadcast content received by the system 100 can be interpreted by the encoding engine 26-6 using the secret keys to decode the (encoded content). Since the RTC unit 26-4 provides information on the use period of the received broadcast content, the RTC unit 26-4 should be protected from unauthorized access.

The first processor 15 or the second processor 22 can selectively access the security sub-system 26 via a selection circuit such as a multiplexer 24. Each of the security monitors 18-1 and 18-2 monitors a corresponding bus master, for example, the first processor 15 and the DMA device 17, which belong to the non-security domain 10 of the bus masters of the system bus 11.

Each of the security monitors 18-1 and 18-2 monitors memory accesses by the corresponding bus master included in the non-security domain 10 to determine whether an address on the system bus 11 matches an address (or falls within a range of addresses) belonging to a predetermined secure domain of the security domain 20.

Thus, the system 100 according to the present embodiment can be embodied by the MCU that doest not support TrustZone because activities of the bus masters (such as memory accesses via the system bus 11) are monitored by the security monitors and, therefore, need not be incorporated into the design of the MCU, which may allow the use of a standard MCU rather than a customized MCU. The security domain setting register unit 16 stores information about access rights and addresses included in predetermined security domain.

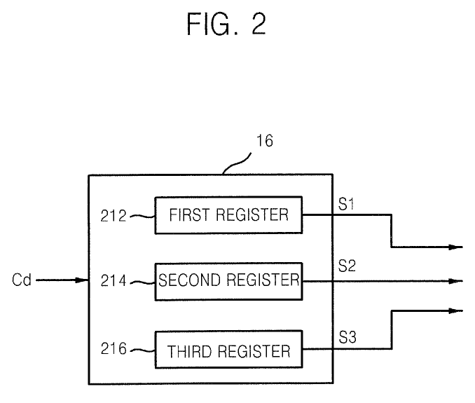

FIG. 2 is a block diagram showing an example of the structure of the security domain setting register unit of FIG. 1. Referring to FIGS. 1 and 2, the security domain setting register unit16 includes a first register 212, a second register 214, and a third register 216. The first register 212 stores information S1 indicating memory access rights for a corresponding bus master. For example, the first register 212 can store information S1 indicating whether an address (or address area of memory) is accessible, not accessible, or read only by the corresponding bus master.

The second register 214 stores information S2 about start addresses of predetermined security domains. The third register 216 stores information S3 about the sizes of the predetermined security domains, for example, offset. The security domain setting register unit16 stores the information S1, S2, and S3 about the addresses of the security domains. The information S1, S2, and S3 about the addresses of the security domains can be programmed at the security domain setting register unit16 through the execution of the user program by the first processor 15, for example, the MCU.

Thus, to protect the information programmed at the security domain setting register unit16 from the attack by an external user, for example, a hacker, the information about the security domains can be programmed at the security domain setting register unit16 in linkage with (or as part of) a secure boot, if the system 100 supports a secure boot process.

In detail, the MCU 15 executes the secure boot. The domain of executing the secure boot is an domain where an external user cannot intrude. Thus, the MCU 15 can program the information about the security domains at the security domain setting register unit16 based on a secure boot code executed in the secure boot process.

Resetting of the security domains at the security domain setting register unit16 by the MCU 15 should be prevented after the secure boot is completely executed. When the secure boot is complete, the second processor 22, e.g., the DSP, generates a control signal Dis to block the access by the MCU 15 to the security domain setting register unit16. For example, the MCU 15 is disabled from accessing the security domain setting register unit 16 in response to the control signal Dis.

Consequently, each of the security monitors 18-1 and 18-2 can monitor a corresponding bus master based on the information S1, S2, and S3 about the security domains stored in the security domain setting register unit 16. For example, the first security monitor 18-1 compares an address included in an access by the first processor with the address of the security domains set based on the information S1, S2, and S3 stored in the security domain setting register unit16, and outputs the result of the comparison. The respective security monitor 18-2 may have the same or similar functions.

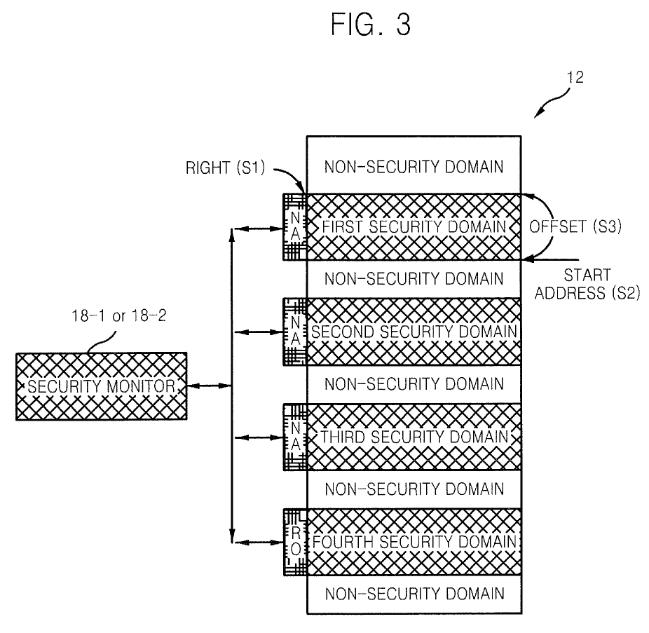

FIG. 3 illustrates security domains setup based on the information programmed in the security domain setting register unit16 of FIG. 2. Referring to FIGS. 2 and 3, four security domains #1 through #4 can be setup in the shared memory 12. In the shared memory 12, areas excluding the security domains #1 through #4 are include in the non-security domain.

For example, the first security domain #1 is non-accessible area and may be a data section area where security data of the second processor 22, for example, the DSP, is located. The second security domain #2 is non-accessible area and may be an area corresponding to a program memory where a security F/W code of the second processor 22, for example, the DSP, is located. The third security domain #3 is non-accessible area and may be a memory area, for example, a RAM, of the DSP 22 having a trap/patch function to patch a ROM code of the DSP 22.

The fourth security domain #4 is an accessible and read only area and may be a memory area where a protection code needed by the DRM with respect to the first processor 15, for example, the MCU, is located. Thus, by the setting of the first and second security areas #1 and #2, the information in the DSP 22 can be protected even when the MCU 15 is attacked by a hacker.

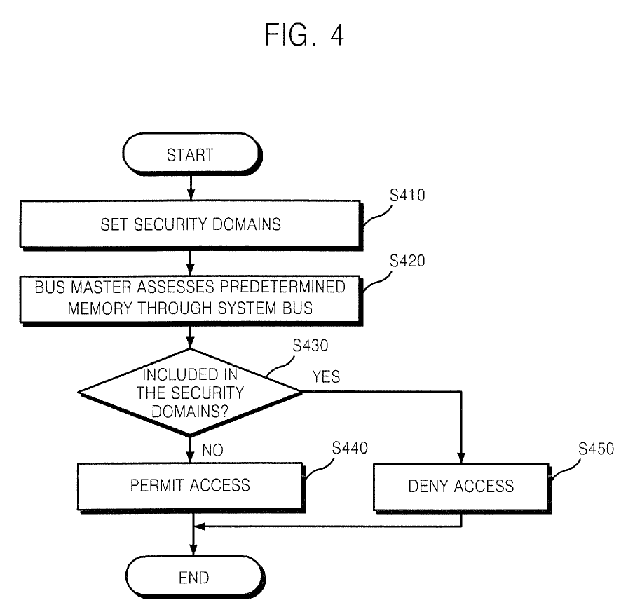

FIG. 4 is a flowchart showing a method for protecting security domains of a system according to an embodiment of the present invention. Referring to FIGS. 1 and 4, the first processor 15 programs the information S1 through S3 to set security domains at the security domain setting register unit 16 (S410). The first processor 15 can program the information S1 through S3 at the security domain setting register unit16 based on the secure boot code Cd.

Any one of the bus-masters 15, 17, and 22 of the system 100 accesses the first address area in the system 100 through the system bus 11 (S420). The security monitor monitors whether the address of the first address area that the bus master accesses matches any one of the addresses of the set security domains (S430).

For example, the first processor 15, for example, an MCU, tries to access an area assigned for security data in a data section of the second processor 22, for example, a DSP. The first security monitor 18-1 can monitor whether the address of an area assigned for the security data in the data section that the MCU accesses matches any one of the addresses of the security domains.

When the addresses do not match each other according to the result of the monitoring, the security monitor 18-1 permits the bus master to access the first address area (S440). In contrast, when the addresses match each other, the security monitor 18-1 denies that the bus master accesses the first address area (S450).

As described above, the system according to the present invention can be embodied using the MCU that does not support TrustZone through the monitoring by the security monitors, which can be located outside the core of the processor which corresponds to the security monitor. Also, in some embodiments according to the invention, the DSP of a dual core of the MCU and DSP sharing the memory address for data communication is set as a security domain so that the efficiency in the use of a memory. Even when the MCU is attacked by a hacker, the information stored in the DSP is safely protected.

Embodiments according to the invention can also be provided as computer readable code stored in a computer readable medium. The computer readable recording medium is any data storage device that can store data which can be thereafter read by a computer system. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A system comprising:
a plurality of bus masters coupled to a system bus; and
a plurality of security monitors each configured to monitor at least one of the plurality of bus masters to determine whether an address issued by the at least one bus master matches any address included in a predetermined security domain of the system.

2. The system of claim 1, wherein the at least one bus master comprises a first processor configured to execute a user program and one of the plurality of security monitors that corresponds to the first processor is configured to monitor whether the address matches address included in the predetermined security domain.

3. The system of claim 2, wherein a second one of the plurality of the bus masters comprises a second processor included in the predetermined security domain.

4. The system of claim 3, wherein the system further comprises:
a shared memory coupled to and shared by the first and second processors.

5. The system of claim 4, further comprising:
a security domain setting register unit coupled to the plurality of security monitors, configured to store information indicating access rights associated with addresses included in the predetermined security domain.

6. The system of claim 5, wherein the first processor is configured to execute a secure boot process to store the information indicating access rights in the security domain setting register unit.

7. The system of claim 6, wherein the second processor disables a program operation with respect to the security domain setting register unit by the first processor after the secure boot process is complete.

8. The system of claim 1, further comprising:
a security domain setting register unit coupled to the plurality of security monitors, configured to store digital rights management information indicating whether a process executed by one of the plurality of bus masters is allowed read/write, read only, or no access to addresses included in the predetermined security domain.

9. The system of claim 1 wherein the plurality of security monitors are outside respective cores used to implement processors used to execute processes having different access rights to a memory shared by the processes.

10. A system comprising:
a first processor configured to execute a user program;
a security domain setting register unit configured to store information indicating access rights associated with addresses included in a predetermined security domain; and
a security monitor, coupled to the security domain setting register unit and the first processor, configured to monitor whether an address issued by the first processor on a system bus matches any address included in the predetermined security domain of the system.

11. The system of claim 10 wherein the information indicating access rights associated with addresses comprises digital rights management information indicating whether a process executed by the first processor is allowed read/write, read only, or no access to the addresses included in the predetermined security domain.

12. The system of claim 10, further comprising:
a second processor included in the predetermined security domain of the system.

13. The system of claim 12, wherein the security domain setting register unit comprises:
a first register configured to store information indicating access rights for each predetermined security domain included in the system;
a second register configured to store start addresses for each predetermined security domain; and
a third register configured to store size information associated with each predetermined security domain.

14. The system of claim 12, wherein the first processor executes a secure boot process to program the information into the security domain setting register unit.

15. The system of claim 14, wherein the second processor disables operations with respect to the security domain setting register unit by the first processor after the secure boot by the first processor is complete.

16. A method of protecting a security domain of a system, the method comprising:
outputting a first address to access a first address area;
comparing the first address to addresses associated with secure areas of a shared memory, the shared memory being accessible to secure and non-secure processes; and
allowing or blocking access to the first address based on whether the first address matches any address within the secure areas of the shared memory.

17. The method of claim 16, further comprising programming security domains using a register during a secure boot to setup at least one security domain.

18. The method of claim 17, further comprising disabling further programming of security domains after the secure boot is complete.

19. The method of claim 16, wherein allowing or blocking access comprises allowing read/write, read only, or no access to the first address based digital rights management information for an associated process that issued the first address.
